(19) United States
(12) Patent Application Publication
(10) Pub. No.: US 2012/0031250 A1
(43) Pub. Date: Feb. 9, 2012

(54) SLICING GUIDE

(75) Inventor: Jon Hocker, Bothell, WA (US)

(73) Assignee: Incise Designs Corporation, Bothell, WA (US)

(21) Appl. No.: 13/198,619

(22) Filed: Aug. 4, 2011

Related U.S. Application Data
(60) Provisional application No. 61/370,764, filed on Aug. 4, 2010.

(51) Int. Cl. B26D 5/00

(52) U.S. Cl. 83/821

(57) ABSTRACT

Slicing guide for slicing food products using a cutting device consisting of a base unit for receiving a food product to be sliced, the base unit consisting of a bottom pan and spaced-apart side walls extending along the pan, the side walls having upper edge portions. The slicing guide also including a top having one end attached to the base unit to be rotatable between an open position rotated away from the base unit and an in-use position wherein the top is pressable against the food product to be sliced. The lower surface of the top cooperating with the upper edges of the side walls to define a guide slot for receiving and guiding the cutting device positioned transversely to the base unit to slice the food product.

### CROSS-REFERENCE TO RELATED APPLICATION

This application claims the benefit of Provisional Application No. 61/370764, filed Aug. 4, 2010.

### BACKGROUND

The present disclosure pertains to a slicing guide especially adapted for kitchen use. The slicing guide is particularly well suited to slice poultry breast meat, which is typically wet and very slippery, and thus difficult to hold in place safely while being sliced.

There is a need to slice poultry breast meat because typical poultry breast meat sold in stores is now quite thick. The meat available today is thick because poultry processors have considerably increased the national average weight per head over time. The increase in overall bird weight correlates directly with an increase in breast meat thickness. More precisely, Chart 1 (see FIG. 26) shows average bird weight moving from 3.5 to 5.6 pounds per bird from 1960 to 2009 according to a USDA database. Chart 2 (see FIG. 27) shows the states that produce larger birds than the national average, up to 7 pounds per head.

These larger birds are grown for economic expediency on the part of the poultry growers and processors, but the downside for customers is they get overly thick poultry breast meat and overly large portions. The increased size poultry makes the poultry meat difficult to thoroughly cook properly from a food safety point of view. Often such breast meat is now 30 mm thick or more. Breast meat that is 15 mm thick requires approximately 15 minutes for proper cooking. To cook breast meat that is 35 mm thick requires at least an additional 10-15 minutes. As a result, the exterior of the breast meat may be overcooked, while the interior is undercooked.

The increase in bird size is an ongoing process, requiring innovation so that portions return to historic weight and dimensions. The present invention addresses this need by seeking to control poultry thickness, and it addresses the obesity epidemic by creating portions of proper calorie content.

Moreover, using the present invention for portion slicing product allows for significant plate coverage and/or bun coverage compared to overly thick product. A 130-calorie portion that is 15 mm thick has a much larger surface area (plate coverage and/or bun coverage) than does a 130-calorie product 30 mm thick. So the visual appearance of the food item is improved with slicing as well.

Acknowledging the drawback of overly thick breast meat portions, meat processors have begun to provide factory-sliced portions. However, such portions may cost the consumer up to twice as much per pound as unsliced portions. This is a significant premium that is required to be paid simply to have the breast meat cut to a proper thickness.

The present kitchen slicing guide seeks to address the foregoing issues by providing a slicing guide that can safely hold breast meat stationary while being sliced to a desired thickness using a standard kitchen knife. Alternatively, an electric or otherwise powered knife can be used with the present cutting guide.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In an aspect of the present disclosure, a slicing guide is provided for slicing a work piece using a cutting device. The slicing guide includes a base unit having spaced-apart side walls extending along the base unit. The side walls define upper edge portions and are configured to receive a work piece to be sliced therebetween. The slicing guide also including a top cooperating with the base unit to be pressable against the work piece during slicing of the work piece. The top having a lower surface cooperating with the upper edges of the base unit to define a guide slot for receiving and constraining the cutting device while slicing the work piece.

The top may be attached to the base unit to be rotatable between a retracted position away from the base unit and an in-use position wherein the lower surface of the top is bearable against the top of the work piece being sliced.

A stop is provided for limiting the movement of the top toward the base unit. The stop may include an abutment extending upwardly from the base unit to an elevation above the upper edges of the spaced-apart walls. The stop may be of another configuration such as consisting of a portion of a top projecting downwardly to bear against the base unit.

The base unit may include a pan portion extending between the spaced-apart walls. The pan may be configured to receive and support the work piece. The pan may be horizontal or sloped.

In accordance with a further aspect of the present disclosure, one or both of the pan and top may be contoured to be engageable with the work piece and thereby achieve enhanced friction against a work piece, helping to hold the work piece in place while being sliced. The contours of the pan and/or top may be of numerous configurations, including lugs projecting from the pan and a top, grooves formed in the pan and a top, indentations formed in the pan and a top, as well as projections extending from the pan and the top.

In a further aspect of the present invention, an insert may be disposable between the support walls and placed on the pan thereby to receive and support a work piece to be sliced. The insert effectively raises the level of the pan, thereby decreasing the thickness of the work piece slice cut using the present slicing guide. This insert may be horizontal or sloped relative to the pan.

In a further aspect of the present invention, an abutment extends laterally outwardly and along one of the spaced-apart walls. The abutment serves to limit the movement of the cutting device relative to and generally lateral to the spaced-apart walls. The abutment may consist of portions of the top extending downwardly to an elevation below the elevation of the upper edge of the spaced-apart wall along which the abutment extends.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is an isometric view of a horizontal slicing guide, illustrating one embodiment of the present disclosure;

FIG. 2 is an isometric view of the base of the slicing guide;

FIG. 3 is an isometric view of the guide portion of the slicing guide;

FIG. 4 is an isometric view of the top of the slicing guide;

FIG. 5 is an isometric view of the slicing guide top, providing a view of the underside of the top;

FIG. 6 is a plan view of the slicing guide of the present disclosure;

FIG. 7 is a side elevational view of FIG. 6;

FIG. 8 is an end view of FIGS. 6 and 7, taken from the right-hand end thereof;

FIG. 9 is a plan view of the guide portion of the slicing guide;

FIG. 10 is a schematic view of a further embodiment of the present disclosure illustrating the kitchen slicing guide being used to cut a poultry breast;

FIG. 11 is a view similar to FIG. 10 with the user applying force to the top of the slicing guide to hold the poultry breast in place while slicing the breast;

FIG. 12 is an isometric view of a horizontal slicing guide, illustrating another embodiment of the present disclosure, including a base, top, and thickness adjustment plate;

FIG. 13 is an isometric view of the base of the slicing guide;

FIG. 14 is an isometric view of the top of the slicing guide;

FIG. 15 is an isometric view of the slicing guide top, providing a view of the underside of the top;

FIG. 16 is a plan view of the slicing guide of the present disclosure;

FIG. 17 is a side elevational view of FIG. 16;

FIG. 18 is an end view of FIGS. 16 and 17, taken from the right-hand end thereof;

FIG. 19 is an isometric view of a thickness adjustment plate for the slicing guide;

FIG. 20 is a schematic view of a further embodiment of the present disclosure, illustrating the slicing guide in use to cut a poultry breast;

FIG. 21 is a view similar to FIG. 20, with the user applying force to the top of the slicing guide to hold the poultry breast in place while slicing the breast;

FIG. 22 is a schematic view of the use of the slicing guide to slice the work product horizontally relative to the slicing guide base;

FIG. 23 is a view similar to FIG. 22, but with the slicing guide making a diagonal cut through the work piece;

FIG. 24 is a view similar to FIGS. 22 and 23, showing the work piece supported on a diagonal base or insert, and with a horizontal cut being made through the work piece;

FIG. 25 is a view similar to FIGS. 22, 23, and 24, showing the base unit or insert therefor adapted for slicing a nominally thinner work piece;

FIG. 26 is a chart showing the weight of an average poultry bird from 1960 to 2009;

FIG. 27 is a chart showing the average poultry bird weight on a per state basis.

### DETAILED DESCRIPTION

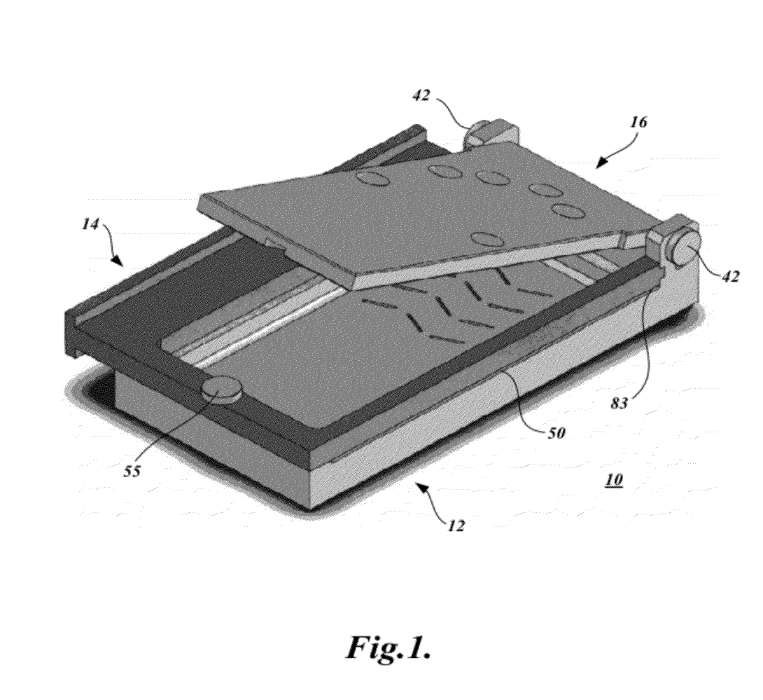

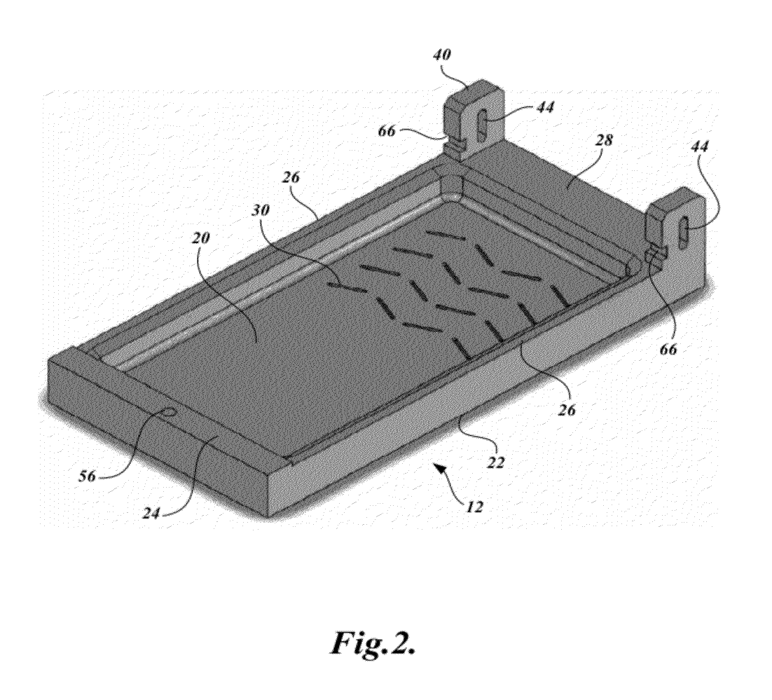

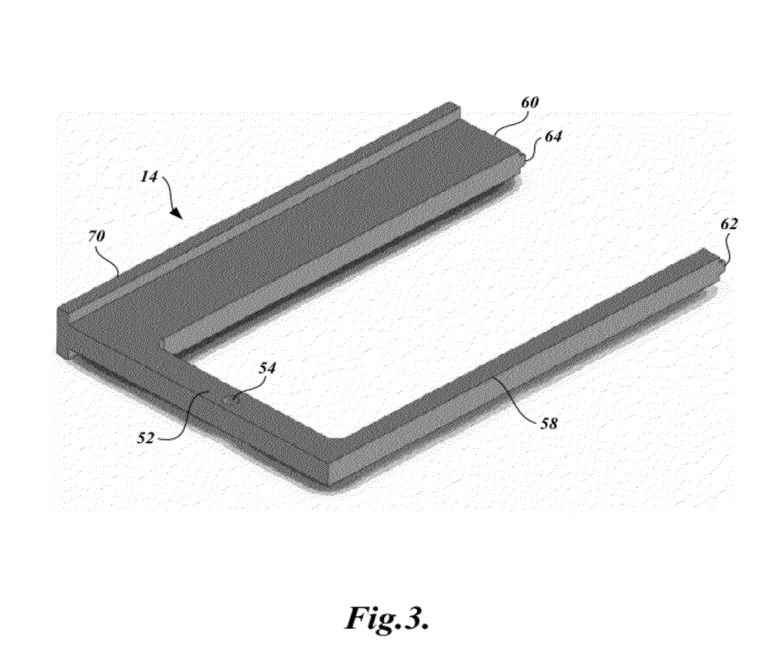

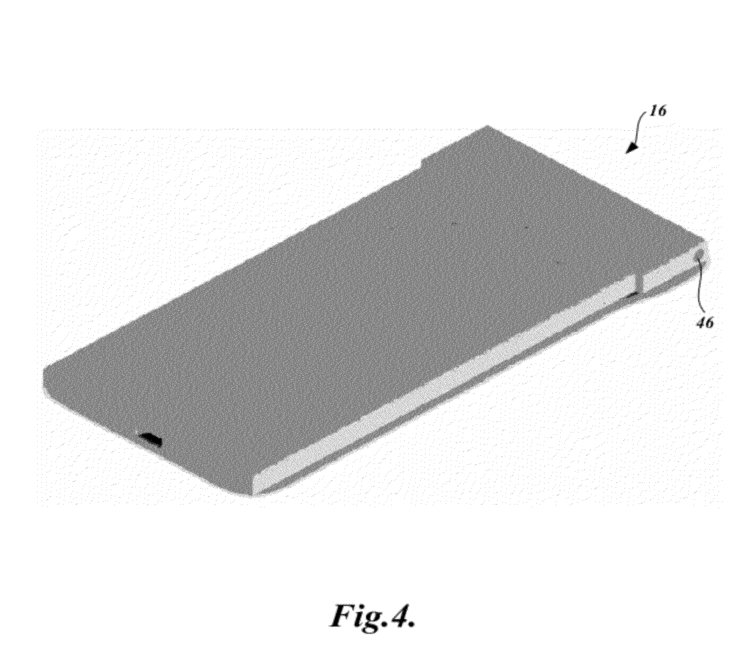

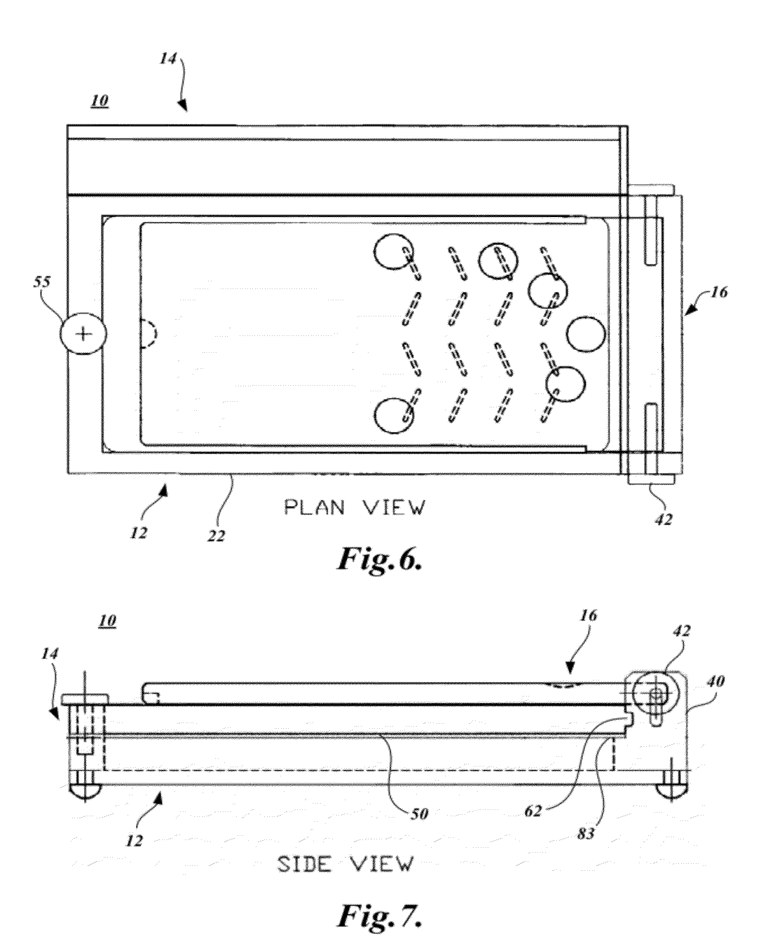

A slicing guide 10 of the present disclosure, as shown in FIGS. 1-9, consists of a base unit 12, a guide member 14 attachable to the top of the base unit, and a hinged cover or top 16, used to hold the food product, such as a poultry breast, between the base unit and the top. Referring specifically to FIGS. 2 and 6, the base unit is constructed with a flat, horizontal or sloped bottom base plate 20, surrounded by an upwardly-extending perimeter frame 22. The reason for sloping the base plate is discussed herein. The proximal or left end section 24 of the perimeter frame 22 extends upwardly slightly higher than the elevation of the side sections 26 and forward or distal section 28. A series of grooves 30 are formed in the base plate 20, which can receive the food product therein to assist in holding the food product stationary when being sliced. Alternatively, the grooves 30 can be replaced with upwardly-projecting lugs to serve the same purpose.

The base unit can be constructed to be “water” or “liquid-tight” thereby to capture and retain the meat juices from the cut food product.

A pair of spaced-apart brackets 40 extend upwardly from the sides of the base distal end 28 to receive the forward or distal end of the cover 16 therebetween. Pins 42 extend through elongated slots 44 formed in the brackets 40 to engage within blind bores 46 formed in the end portion of the cover 16.

Next, referring specifically to FIGS. 1, 3, and 9, guide member 14 is designed to overlay base 12 to cooperate with the base to define a slot 50 between the underside of the guide member and the top surfaces of the base side portions 26 for receiving a knife or other cutting implement therein. The guide member includes a proximal end section 52 that overlies the end portion 24 of the base. Throughhole 54 is formed in the end portion 52 to receive a fastener 55, such as a screw, which extends through the hole 54 and into a threaded hole 56 formed in base end portion 24 to hold the guide member in place on the base. The guide member also includes a thinner side section 58 to overlie side section 26 of the base and a wider side section 60 to overlie the opposite side section 26 of the base. Keys 62 and 64 are formed in and project outwardly from the ends of the guide side sections 58 and 60 to be receivable within keyways 66 formed in brackets 40 for attachment of the guide 14 to the base unit 12. As an alternative, the keys 62 and 64 can be replaced with pins that project outwardly from the ends of the guide side sections 58 and 60 to be receivable within holes formed in brackets 40.

An abutment wall 70 extends along the outer edge of guide side section 60 to serve as a stop for the knife when engaged in the slot 50 to slice the food product being held by the slicing guide 10.

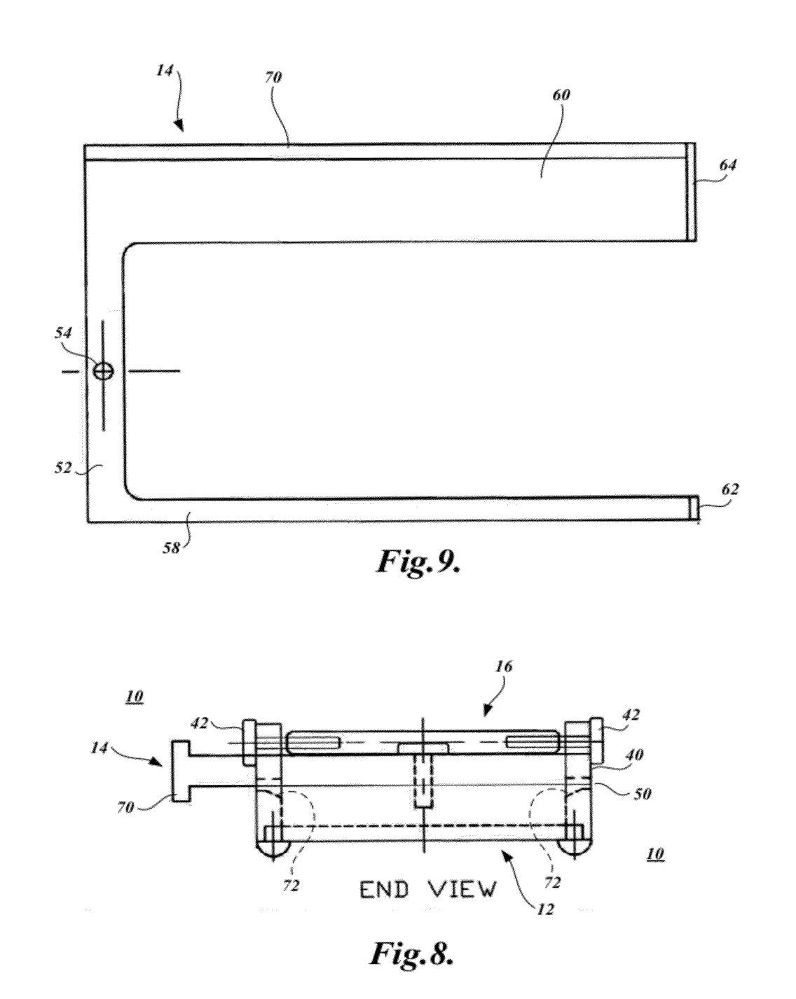

As shown in FIG. 8, the upper edge 72 of base side portions 26 is tapered, sloped, curved, or beveled downwardly in the inward direction. This serves multiple purposes. It provides a wider entry for the cutting knife when inserting the knife into the slot 50, especially when the knife is inserted into the slot on the side of the base 12 adjacent the abutment wall 70. Also forming the upper edge 72 in this manner facilitates the cleaning of the slicing guide 10, especially if the guide is not disassembled during cleaning, for example, in a dishwasher.

The guide member 14 is illustrated as positioned in one orientation with respect to the base unit 12 in FIG. 1. However, the guide member 14 may be “flipped over” so that the wider section 60 overlies the opposite side of the base side section 26, thereby converting the slicing guide 10 for left hand use. In such case, the knife used to slice the food product engages slot 50 from the opposite side of the base unit 12.

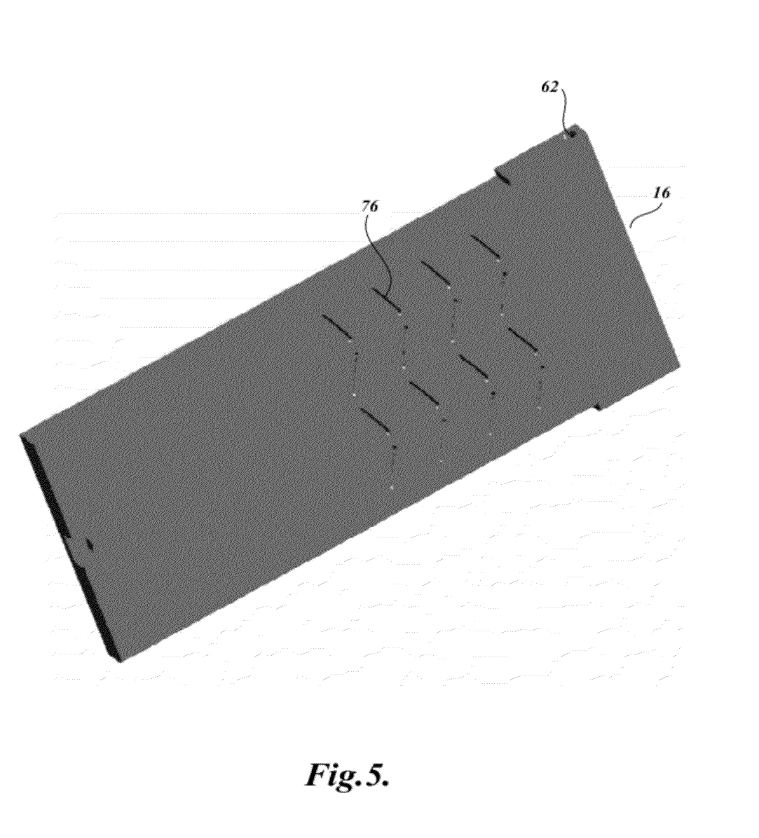

As shown in FIG. 5, grooves or slots 76 can be formed in the underside of the cover 16 to receive the food product therein, thereby to assist in holding the food product stationary while being sliced. Thus the slots 76 function in the same manner as slots 30 formed in the base 12.

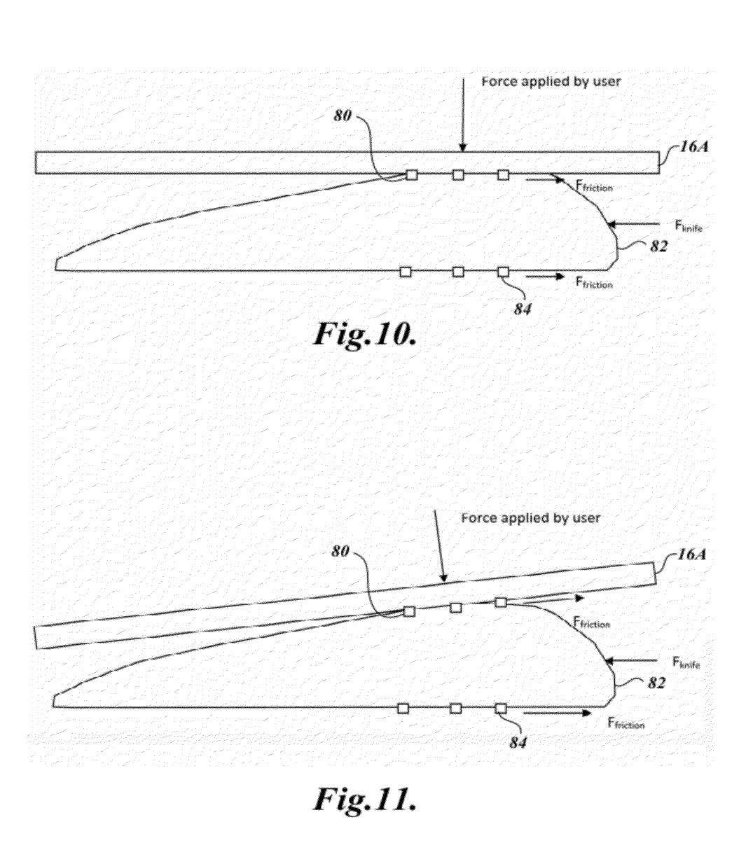

A further embodiment of the present disclosure is shown in FIGS. 10 and 11, wherein the cover is designated as part number 16a. As shown in FIGS. 10 and 11, a series of transverse lugs 80 project downwardly from the underside of the cover 16a to help hold the food product 82 in place while being sliced. Similar lugs 84 are formed in base plate 20 to project upwardly therefrom, in the same manner that the upper lugs 80 project downwardly from the underside of cover 16a.

Traction lugs 80 and 84 are utilized to help hold the food product in place while being sliced, as shown in FIGS. 10 and 11. The same function is performed by grooves 30 in base plate 20, and grooves 76 formed in the underside of cover 16, see FIGS. 2 and 5. Other methods or techniques may be used to perform this function. For instance, the lugs 80 and 84 and the grooves 30 and 76 may be replaced by circular dimples, by half-moon shaped protruding lugs, by lugs in a diamond pattern, etc. Also, the surfaces of the base plate 20 and/or the underside of cover 16 may be textured or otherwise formed to increase traction or friction with the food product being sliced. In addition, the slicing guide 10 may be constructed without any type of traction assistance since, as discussed below, the wedge action of the hinged cover or top 16 likely is more than sufficient to hold the food product in place during slicing. Also, in some situations, the cover 16 does not need to be utilized at all when the food product, such as a large piece of beef, is being sliced, in which case, the user need only hold the top surface of the beef itself, at least for the first several slices being cut.

To use the slicing guide, food product 82 is placed on the base unit 12 between the side sections 26 thereof. The result of such placement is that some of the food item is above slot 50 and some is below slot 50 through which the user will insert a knife at point 83. At point 83, the components of the slicing guide 10 cooperate to create a guiding surface that allows the user to easily insert the knife the full width of the base unit 12 until the tip of the knife reaches abutment wall 70. The user inserts the knife with the sharp edge facing the proximal end of base 12 (facing away from hinge point). The user oscillates the knife as illustrated in FIG. 6, while simultaneously translating the knife toward the proximal end of slot 50. Alternately, an electronic oscillating knife or other means can be used to slice the product. Were it not for the guiding surface at 83, the user would have to “fish around” to get the knife inserted correctly into the far slot.

During the cutting process, the cover is then pivoted downwardly to overlie the food product, as shown in FIG. 10. Also, during the cutting process, downward force is applied to the cover, which causes the forward end of the cover to move upwardly, as pins 42 slide upwardly within the slots 44, and the rear or proximal end of the cover to move downwardly to be positioned somewhat tangentially to the upper surface of the food product. It will be appreciated that typically poultry breasts are tapered along their length in a mariner shown in FIGS. 10 and 11. The present slicing guide, allowing the proximal end of the cover to be lowered relative to the distal end, enables the food product to be held securely in place while the food product is being sliced. Moreover, the amount of force applied to the proximal end of the cover can be varied to match the level force required to hold the food product in place without applying so much force so as to excessively smash or compress the food product. Also, because the proximal end of the cover is lower than the distal end, a wedge is formed so that the food product is held in place without slipping while being cut.

The cutting guide 10 can be constructed of various sizes to cut food products into differing thicknesses and sizes. For example, in one configuration, the height of the side sections 26 above the top surface of the bottom plate 20 of the base unit 12 can be selected for optimal thickness of poultry breasts. However, if the cutting guide is designed primarily for other purposes, or for cutting other types of food products, the height of the side sections 26 may be greater or less than shown in FIG. 2.

Also, the base unit 12 can be constructed so that the heights of the side sections is adjustable. For example, some recipes may call for 10 mm product instead of 15 mm product. The device can be designed a bit differently than shown so as to accomplish a user-selectable range of thickness settings. Breaded products typically have different (thinner) ideal thickness than grilled (unbreaded) products. This device would easily be made to achieve an additional thickness setting with the addition of a drop-in plate that simply increases the elevation of the bottom of base unit 12 in FIG. 2. Additional plates lead to thinner sliced product. Alternate embodiments of the device can cut the product in half instead of cutting horizontally. This can mean cutting at an angle instead of horizontally.

It will be appreciated that the cutting guide shown in the foregoing

FIGS. 1-11 may be easily disassembled for cleaning in a dishwasher or sink. In this regard, fasteners 55 and 42 may be easily removed, thereby to completely disassemble the cutting guide. Also, it will be appreciated that, when in use, the user's hand is kept safely away from the knife or other cutting device used for slicing the food product while still securely holding the food product in place. Moreover, the abutment wall 70 provides a stop for the tip of the slicing knife to constrain the knife and prevent the knife tip from projecting beyond the cutting guide.

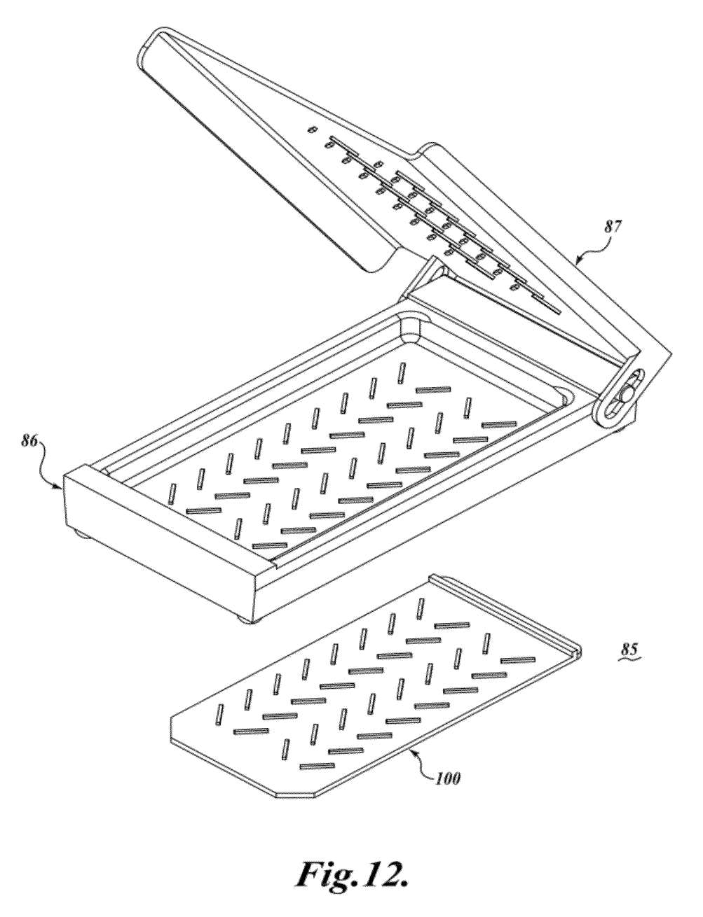

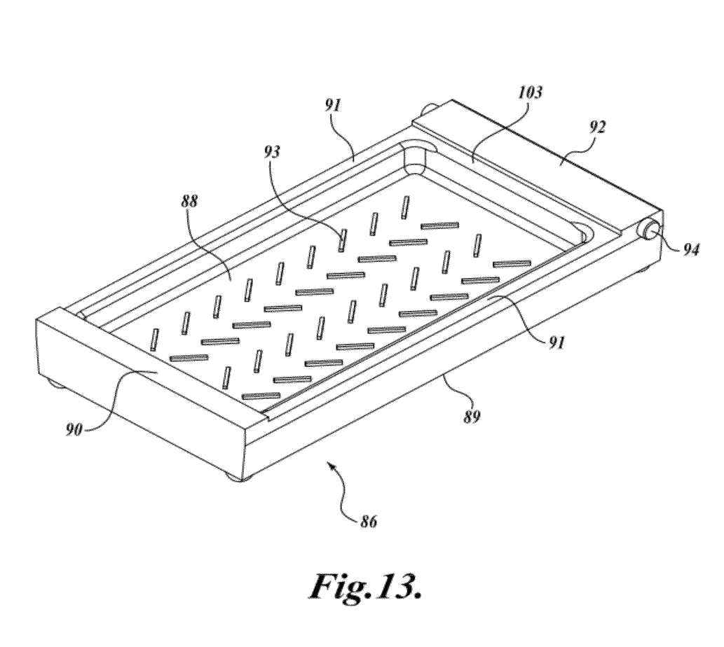

A slicing guide 85 of the present disclosure, as shown in FIGS. 12-19, consists of a base unit 86, a guide member integrated into the top of the base unit, and a hinged cover or top 87, used to hold the food product, such as a poultry breast, between the base unit and the top. Referring specifically to FIGS. 13 and 16, the base unit is constructed with a flat, horizontal, rectangularly-shaped bottom base plate or pan 88, surrounded entirely or partially by an upwardly-extending perimeter frame 89. The base unit can also be sloped as discussed herein. Also, the base plate or pan can be of other shapes such as oval or circular, to better match the food product being sliced. The proximal or left end section 90 of the perimeter frame 89 extends upwardly slightly higher than the elevation of the side sections 91 and is at the same elevation as the forward or distal section 92. (As explained herein, end sections 90 and 92 cooperate with the top 87 to provide a gap for a knife or other type of cutting device.) A series of upwardly-extending lugs 93 or other projections are formed in the base plate 88, which can receive the food product therein to assist in holding the food product stationary when being sliced. Alternatively, the lugs 93 can be replaced with grooves or other projections or indentations to serve the same purpose. The lugs are arranged in rows extending along the length of the base plate and positioned in diagonal orientation relative to the length of the base unit 56. However, the lugs can be in other orientations and positions.

The base unit can be constructed to be “water” or “liquid-tight” thereby to capture and retain the meat juices from the cut food product.

A pair of round protrusions 94 extend laterally from the sides of the base distal end 92 to engage slots 107 formed in mounting bracket 95 at the forward or distal end of the cover 87. Slotted mounting bracket 95 snaps over lugs 94 without the use of tools or fasteners at assembly.

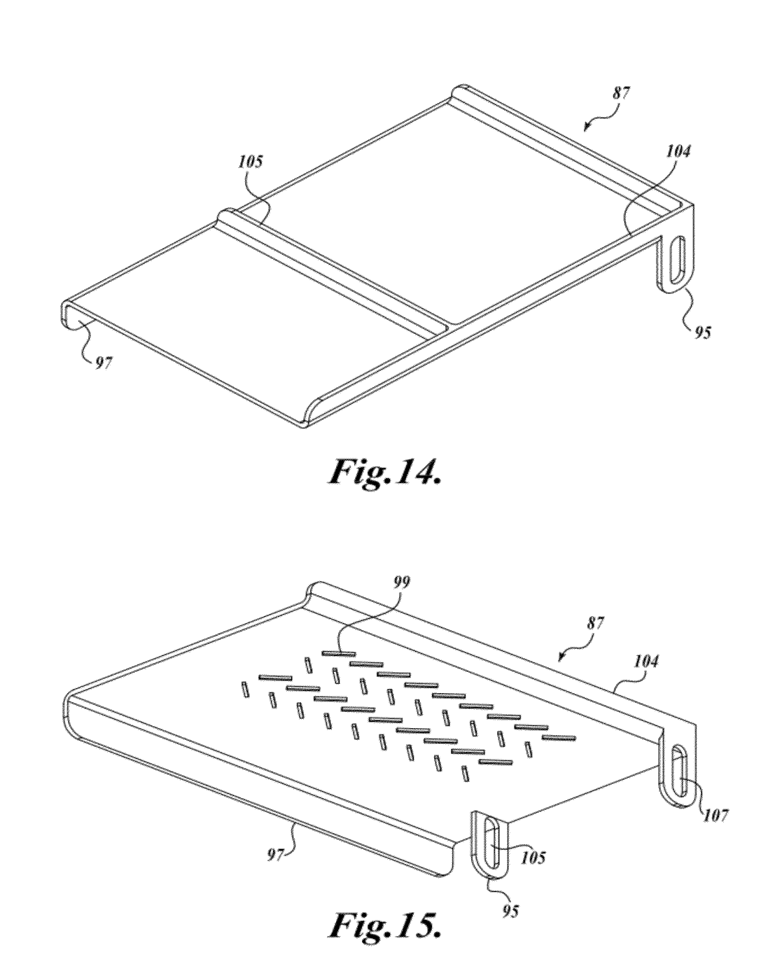

Next, referring specifically to FIGS. 14 and 17, hinged cover or top 87 is designed to overlay base unit 86 to cooperate with the base to define a minimum height slot 96 between the underside of the hinged cover and the top surfaces of the base side portions 91 for receiving a knife or other cutting implement therein. The cover 87 overlays and rests on base end section 90 to thereby define slot 96. Slot 96 increases in vertical dimension when product is placed into base unit 86 and is shown at its minimum dimension in FIG. 17. The slicing guide 85 is held in place on a counter or other surface during operation by feet 106 which project downwardly from base unit 86, which generate traction between base 86 and the counter or other supporting surface.

Next, referring specifically to FIGS. 14, 15, and 18, an abutment wall or lip 97 extends downward along the outer edge of hinged cover or top 87 to serve as a stop for the knife when engaged on top of base side portions 91 to slice the food product being held by the slicing guide 85. The abutment wall is spaced outwardly of the adjacent base sidewall 91. An additional abutment wall or lip 104 extends upward along the outer edge of hinged cover or top 87 to serve as a safety barrier. The abutment prevents the users from having fingers or thumbs in the knife area. A transverse, vertical stiffener 105 extends across top 87 and similarly provides safety by providing a grasp point that is away from the knife zone. Moreover, the abutment walls/lips 97 and 104 and transverse stiffener 105 add rigidity and structural integrity to the cover 87. Also, one or more of the abutment walls/lips 97 and 104 and transverse stiffener 105 can be made integrally with the top 87 or made separately from the cover and the attached thereto.

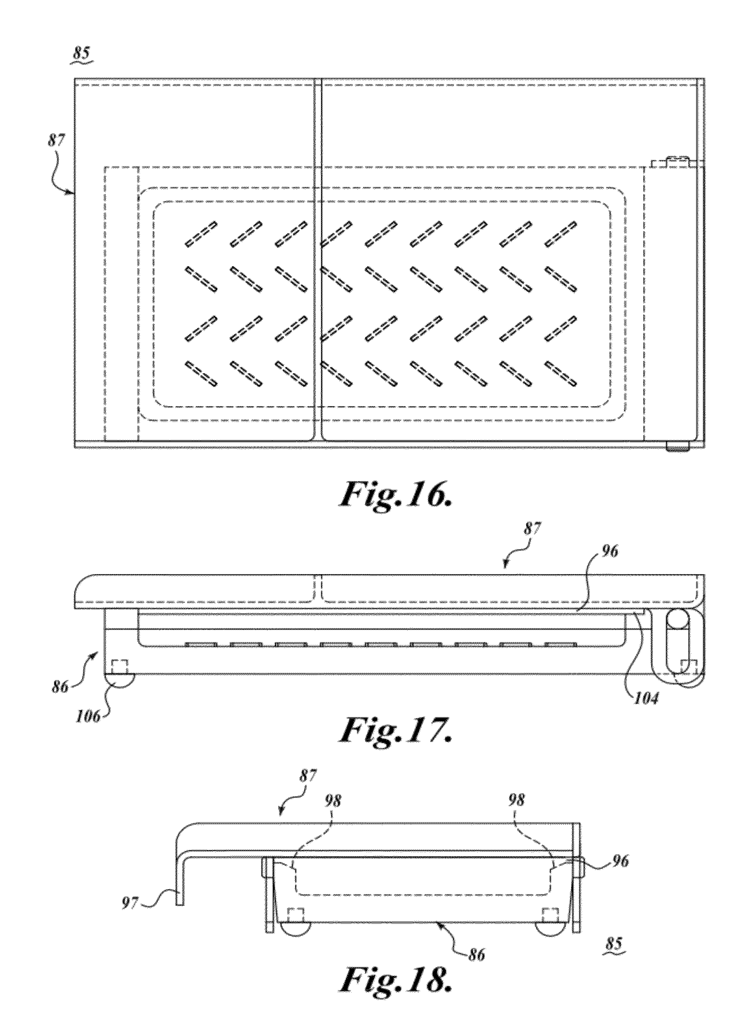

As shown in FIG. 18, the upper edges 98 of base side portions 91 are tapered, sloped, curved, or beveled downwardly in the inward direction. This serves multiple purposes. It provides a wider entry for the cutting knife when inserting the knife into the slot 96. Also forming the upper edge 98 in this manner facilitates the cleaning of the slicing guide 85, especially if the guide is not disassembled during cleaning, for example, in a dishwasher.

As shown in FIG. 15, downward projecting lugs, upward projecting grooves, holes, or slots 99, or other types of projections or indentations can be present in cover 87 to receive the food product therein, thereby to assist in holding the food product stationary while being sliced. Thus the traction devices 99 function in the same manner as upwardly-projecting lugs or downwardly projecting grooves 93 formed in the base 86.

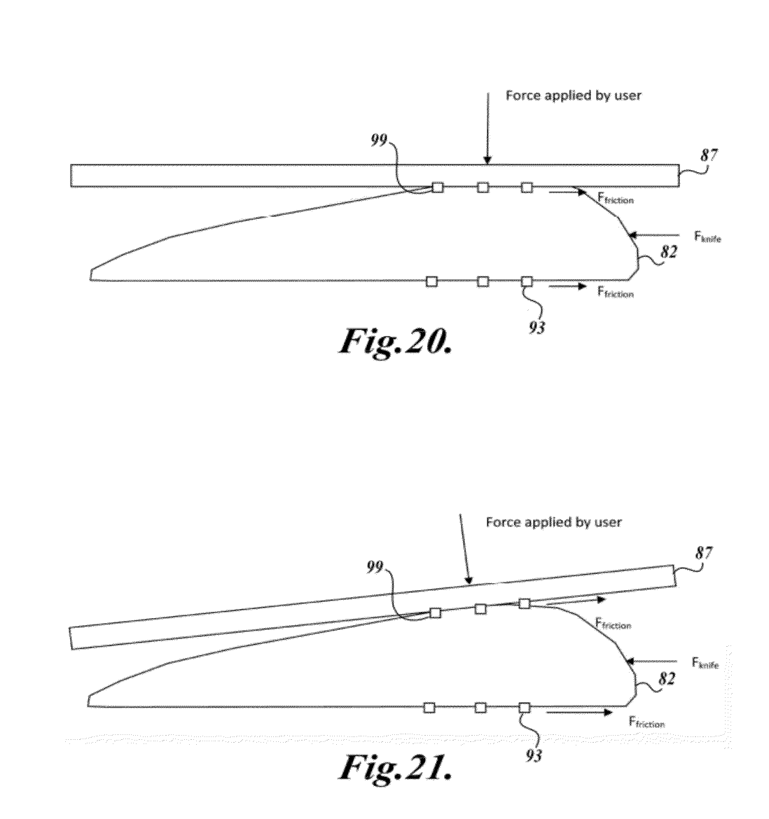

A further embodiment of the present disclosure is shown in FIGS. 20 and 21, wherein the cover is designated as part number 87A. As shown in FIGS. 20 and 21, a series of transverse lugs 99 project downwardly from the underside of the cover 87A to help hold the food product 82 in place while being sliced. Similar lugs 93 are formed in base plate 88 to project upwardly therefrom in the same manner that the upper lugs 99 project downwardly from the underside of cover 87A.

Traction lugs 93 and 99 are utilized to help hold the food product in place while being sliced, as shown in FIGS. 20 and 21. The same function is performed by grooves in base plate 88 and grooves or slots in cover 87. Other methods or techniques may be used to perform this function. For instance, the lugs 93 and 99 may be replaced by circular dimples, by half-moon shaped protruding lugs, by lugs in a diamond pattern, etc. Also, the surfaces of the base plate 88 and/or the underside of cover 87 may be textured or otherwise formed to increase traction or friction with the food product being sliced. In addition, the slicing guide 85 may be constructed without any type of traction assistance since, as discussed below, the wedge action of the hinged cover or top 87 likely is more than sufficient to hold the food product in place during slicing for some combination of food item and knife characteristics. Also, in some situations, the cover 87 does not need to be utilized at all when the food product, such as a large piece of beef, is being sliced, in which case, the user need only hold the top surface of the beef itself, at least for the first several slices being cut.

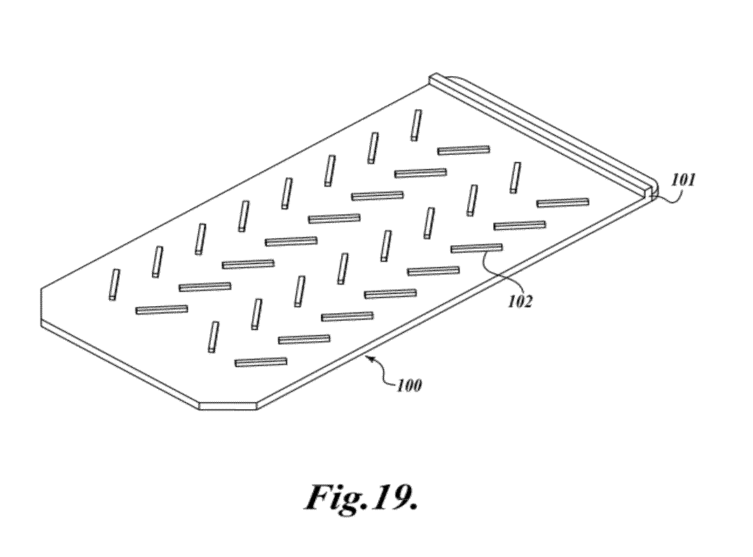

Next, referring specifically to FIG. 19, thickness adjustment plate 100 is designed to overlay pan surface 88 of base unit 86 to cooperate with the base to define thinner slice dimensions. Thickness adjustment plate 100 has protrusion 101 extending across its distal end. When plate 100 is loaded into base 86 with protrusion 101 facing upward, slice thickness decreases by 3 mm. When plate 100 is loaded into base 86 with protrusion 101 facing downward, slice thickness decreases by 6 mm minimum. The user-selectable thickness options therefore possible with the current embodiment of the design include 15, 12, and 9 mm. Adjustment plate 100 includes traction devices 102 similar in function and design to lug or slot 93 in base unit 86; and lug, slot, or hole 99 in cover 87. The traction devices 102 are arranged such that they do not interfere with lugs 93 when adjustment plate 100 is inserted into base unit 86.

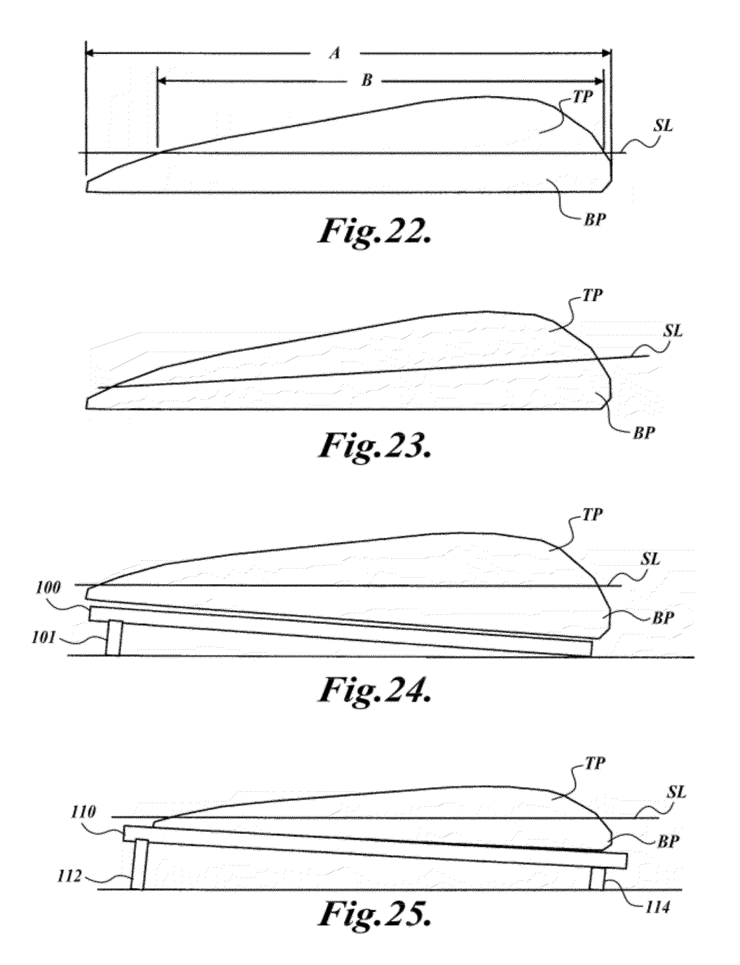

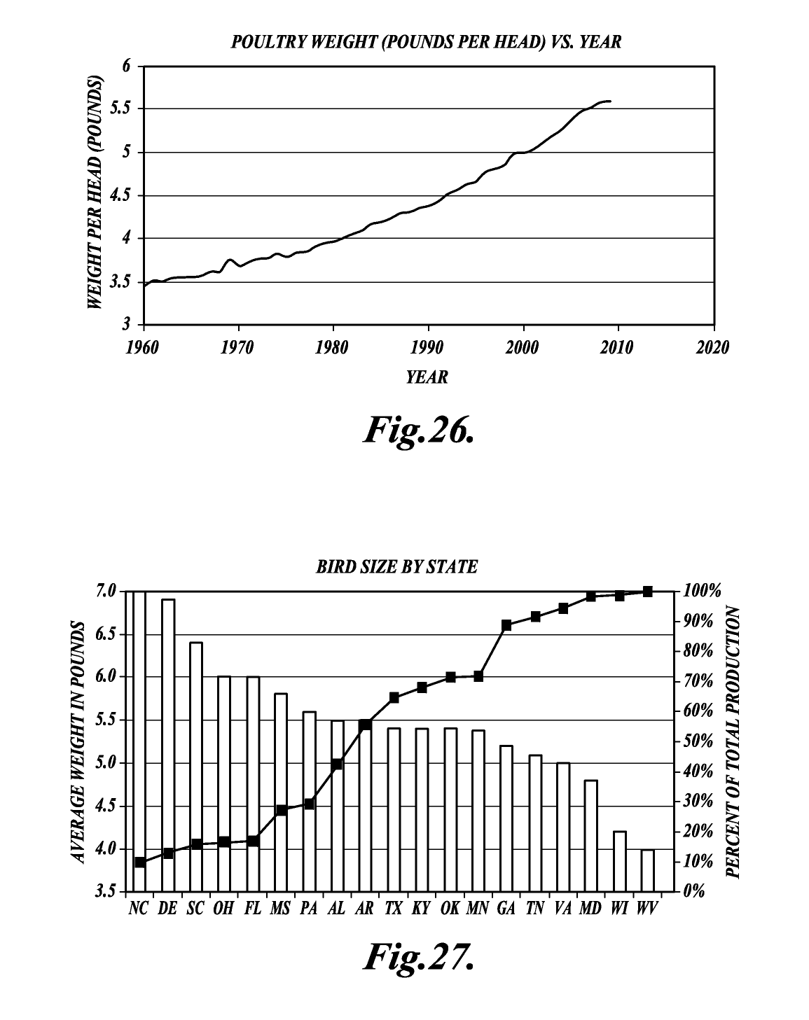

Referring to FIGS. 22-25, these figures show how the present slicing guide 85, with an insert 100, 110 or other insert configuration(s), can be used to slice work pieces/food products using various slicing strategies depending on the desire to achieve end products of uniform thickness, uniform or similar size, weight, area, or thickness, or a combination of these physical criteria. The slice line SL is shown in each view as well as the resulting top piece TP and bottom piece BP.

FIG. 22 shows the basic design which employs a horizontal slice. The top piece TP ends up larger than the bottom piece BP. Dimension A is larger than dimension B owing to the three-dimensional shape of the meat. The top portion is considerably smaller in area than the bottom portion. For a larger piece of meat meat and the thickest setting of 15 mm, the top and bottom pieces are typically of adequate size to be acceptable in terms of weight, thickness, calorie content, and area (plate or bun coverage). The bottom piece is of uniform thickness. This is a standard design and perhaps easiest to explain and use.

FIG. 23 illustrates the benefit of a tapered slice with meat horizontally positioned in the slicing guide, as in FIG. 22, for purposes of easy comparison and clarity. If the goal of the user is to achieve more evenly-sized pieces instead of precisely uniform thickness control for cooking purposes as shown in FIG. 23, an angled slice can be beneficial. The top and bottom pieces shown in FIG. 23 are of more equal size but are of less uniform thickness than the bottom piece shown in FIG. 22.

FIG. 24 illustrates how the meat may be held on an insert 100 to achieve the result shown in FIG. 23. Protrusion 101 is located nearest end section 90 (FIG. 13) to generate the desired effect. The benefit of using insert plate 100 is that a simple part is available that can be easily customized for various customer needs. It is often unknown if users will want uniform thickness pieces as are produced in the bottom pieces of FIG. 22, or pieces of more uniform size with variable thickness as in FIG. 23 and also accomplished in FIG. 24. The slicer guide 85 described here is capable of both modes.

FIG. 25 shows an insert plate 110 design usable to achieve a tapered cut on smaller sized meat. In this situation, plate 110 uses protrusions 112 and 114 at opposite ends. Smaller meat does not typically need slicing; so while the device 85 can accommodate the tapered slicing of smaller meat, the demand for the slicer guide configuration of FIG. 25 is not expected to be significant in the U.S., but may be more significant in Canada and other countries where such product is popular.

Note that FIG. 12 shows plate 100 configured to be dropped into place for a horizontal 12 mm cut (not an angled cut which would put the lug at the other end). This design of the slicer guide is contemplated to automatically slope the cut to achieve the most equal-sized pieces possible. It will be appreciated that the slicer guide 85 is adapted to be useful to those that prefer uniform thickness (for best cooking) or more uniform size.

To use the slicing guide, food product 82 is placed on the base unit 86 between the side sections 91 thereof. The result of such placement is that some of the food item is above the elevation of the side sections 91 and some of the food items is below side sections 91. The user then moves cover 87 to the position shown in FIG. 21. At point 104 (FIG. 17), the knife insertion area is created by flat surface 103 in base unit 86 (FIG. 13), which allows the user to easily insert the knife the full width of the base unit 86 until the tip of the knife reaches abutment wall 97. The user inserts the knife with the sharp edge facing the proximal end of base 86 (facing away from hinge point). The user oscillates the knife while simultaneously translating the knife toward the proximal end of base unit 86, slot 96. Alternately, an electronic oscillating knife or other means or devices can be used to slice the product. Were it not for the guiding surface at 103, the user would have to “fish around” to get the knife inserted correctly on top of side section 91 near abutment wall 97.

During the cutting process, the cover is then pivoted downwardly to overlie the food product, as shown in FIG. 20. Also, during the cutting process, downward force is applied to the cover, which causes the distal end of the cover 87 to move upwardly, as the round protrusions 94 allow slotted mounted brackets 95 to slide upwardly and the rear or proximal end of the cover to move downwardly to be positioned somewhat tangentially to the upper surface of the food product. It will be appreciated that typically poultry breasts are tapered along their length in a manner shown in FIGS. 20 and 21. The present slicing guide, allowing the proximal end of the cover to be lowered relative to the distal end, enables the food product to be held securely in place while the food product is being sliced. Moreover, the amount of force applied to the proximal end of the cover can be varied to match the level force required to hold the food product in place without applying so much force so as to excessively smash or compress the food product. Also, because the proximal end of the cover is lower than the distal end, a wedge is formed so that the food product is held in place without slipping while being cut.

The slicing guide 85 can be constructed of various sizes to cut food products into differing thicknesses and sizes. For example, in one configuration, the height of the side sections 91 above the top surface of the bottom plate 88 of the base unit 86 can be selected for optimal thickness of poultry breasts. However, if the cutting guide is designed primarily for other purposes, or for cutting other types of food products, the height of the side sections 91 may be greater or less than shown in FIG. 13.

Also, the base unit 86 can be constructed so that the height of the side sections is adjustable. For example, some recipes may call for 9 mm product instead of 15 mm product. The device can be designed a bit differently than shown so as to accomplish a user-selectable range of thickness settings without the use of plate 100. Breaded products typically have different (thinner) ideal thickness than grilled (unbreaded) products. Alternate embodiments of the device can cut the product in half instead of cutting horizontally. This can mean cutting at an angle instead of horizontally.

It will be appreciated that the cutting guide shown in the foregoing figures may be easily disassembled for cleaning in a dishwasher or sink. Also, it will be appreciated that, when in use, the user's hand is kept safely away from the knife or other cutting device used for slicing the food product while still securely holding the food product in place. Moreover, the abutment wall 97 provides a stop for the tip of the slicing knife to constrain the knife and prevent the knife tip from projecting beyond the cutting guide.

Further, although the cover is shown as being of solid, planar construction, it could be of a lattice, grid, or other “open” construction, thereby to inherently help prevent movement between the cover and the work piece/food product.

Also, although the cover is shown as hinged to the base unit, the cover can be a separate unit that is not per se hinged or attached to the base unit. For example, the cover can be configured to slide downwardly over the base unit or to otherwise be positionable over the base unit, while also cooperating with the base unit to define a slot, such as slot 96, for the cutting device.

While illustrative embodiments have been illustrated and described, it will be appreciated that various changes can be made therein without departing from the spirit and scope of the invention.

1. A slicing guide for slicing a work piece using a cutting device, comprising:
a base unit having spaced-apart walls extending along the base unit, the spaced-apart walls:
having portions defining upper edges of the walls; and
configured to receive therebetween a work piece to be sliced; and
a top cooperating with the base unit to be pressable against a work piece, the top having a lower surface cooperating with the upper edges of the base unit walls to define a guide slot for receiving and constraining a cutting device usable to slice the work piece.

2. A slicing guide according to claim 1, wherein the top is attached to the base unit to be rotatable between a retracted position away from the base unit and an in-use position wherein the lower surface of the top is bearable against the top of a work piece.

3. A slicing guide according to claim 1, further comprising a stop for limiting the movement of the top toward the base unit, said stop at a location spaced from the location where the top is attached to the base unit.

4. A slicing guide according to claim 3, wherein the stop is selected from a group consisting of: an abutment extending upwardly from the base unit to an elevation above the upper edges of the spaced-apart walls; and portions of the top projecting from the top to bear against the base unit.

5. A slicing guide according to claim 1, wherein the base unit comprises a pan portion extending between the spaced-apart walls, said pan portion configured to receive and support a work piece.

6. A slicing guide according to claim 5, wherein one or both of the pan and the top are contoured to be engageable with a work piece.

7. A slicing guide according to claim 6, wherein the contours of the pan and/or the top are selected from a group consisting of:
lugs projecting from the surface of the pan and/or lower surface of the top;
grooves formed in the surface of the pan and/or the lower surface of the top;
indentations formed in the surface of the pan and/or lower surface of the top; and
projections extending from the surface of the pan and/or lower surface of the top.

8. A slicing guide according to claim 1, wherein the lower surface of the top is contoured to be engageable with the work piece.

9. A slicing guide according to claim 1, further comprising an insert disposable between the support walls, said insert adaptable to receive and support a work piece thereon for cutting a thinner slice of a work piece than if the insert were not present.

10. A slicing guide according to claim 9, wherein said insert is of variable thickness thereby to alter the thickness to which a work piece is sliced.

11. A slicing guide according to claim 1, further comprising an abutment extending along one of the spaced-apart walls to serve as an abutment to the movement of the cutting device relative to the spaced-apart wall corresponding to the abutment.

12. A slicing guide according to claim 11, wherein the abutment comprises portions of the top extending downwardly to an elevation lower than the elevation of the upper edge of the spaced-apart wall corresponding to the abutment.

13. A slicing guide for slicing a food product with a cutting device, comprising:
a base unit having a pan and spaced-apart side walls extending upwardly along and extending along the pan, the side walls having upper edge portions, the side walls configured to receive a food product to be sliced therebetween; and
a top moveable relative to the base unit between a retracted position rotated away from the base unit and an in-use position wherein said top is pressable against a food product positionable on the base unit, the lower surface of the top cooperating with the upper edges of the sidewalls to define a guide slot for receiving and guiding a cutting device to slice a food product.

14. A cutting guide according to claim 13, further comprising a stop for limiting the movement of a top toward the base unit at a location spaced from the location where the top is attached to the base unit.

15. A cutting guide according to claim 14, wherein said stop is selected from a group consisting of:
an abutment extending upwardly from the base unit to an elevation above the upper edge portions of the side walls; and
portions of the top projecting from the top to be bearable against a base unit at a location spaced from the location where the top is attached to the base unit.

16. A slicing guide according to claim 13, wherein one or both of the pan and the top are contoured to be engageable with a food product.

17. A slicing guide according to claim 13, further comprising an insert disposable between the side walls and positionable over the pan to receive and support a food product during slicing of food product, said insert altering the thickness of the food product that is sliced using said slicing guide.

18. A slicing guide according to claim 13, further comprising a cutting device abutment extending longitudinally along and spaced laterally outwardly from one of the side walls, said cutting device abutment serving to limit the movement of the cutting device in the direction transverse to the side walls.

19. A slicing device according to claim 18, wherein said cutting device abutment comprises an edge portion of the top extending toward the base unit to an elevation below the upper edges of the side walls when the top is fully rotated toward the base unit.

20. A slicing guide for slicing a work piece with a cutting device, comprising:
a base unit having a pan and spaced-apart side walls extending along the pan, the side walls having upper edges at an elevation above the top surface of the pan;
a guide member attachable to the base unit, said guide member having longitudinal sections extending along the side walls at an elevation spaced above the upper edges of the side walls, the longitudinal sections of said guide member cooperating with the upper edges of the side walls of the base member to define a guide slot for receiving a cutting device; and
a top moveable relative to the base unit to move toward the base unit to press against a work piece positionable on the base unit, and to move away from the base unit to enable a work piece to be placed on and removed from the base unit.
